(19) United States
(12) Patent Application Publication
(10) Pub. No.: US 2005/0074656 A1
(43) Pub. Date: Apr. 7, 2005

(54) Fuel cell, electronic appliance and business method

(75) Inventors: Tohru Koyama, Hitachi (JP); Shigeo Suzuki, Hitachi (JP); Ryo Moteki, Hitachi (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(73) Assignee: Hitachi Maxell, Ltd., Osaka (JP)

(21) Appl. No.: 10/920,312

(22) Filed: Aug. 18, 2004

(30) Foreign Application Priority Data
Oct. 3, 2003 (JP) 2003-345500

(51) Int. Cl. H01M 8/04

(52) U.S. Cl. 429/34; 429/22

(57) ABSTRACT

Disclosure is concerned with a small type fuel cell for a power source of portable electronic appliances, particularly to a fuel cell using liquid fuel such as methanol etc., an electronic appliance, and a method of doing business. The fuel cell characterized by having a circulating container for supplying liquid fuel of a predetermined concentration to the fuel cell and for recovering and storing the liquid fuel discharged from the fuel cell, wherein the circulating container is replaceable.

### CLAIM OF PRIORITY

The present application claims priority from Japanese application serial No. 2003-345500, filed on Oct. 3, 2003, the content of which is hereby incorporated by reference into this application.

### FIELD OF THE INVENTION

The present invention relates to a small type fuel cell for a power source of portable electronic appliances, particularly to a fuel cell using liquid fuel such as methanol etc., an electronic appliance, and a method of doing business.

### BACKGROUND OF THE INVENTION

As a recent progress of electronic technologies, electronic appliances such as portable telephones, notebook type personal computers, audio/visual appliances, mobile terminals, etc. have been downsized as portable electronic appliances and are being populated very quickly. These appliances have heretofore been driven by secondary batteries. Developments of active materials and downsized secondary batteries for increasing energy density have been made so that various batteries such as sealed lead batteries, Ni/Cd batteries, Ni/hydrogen batteries, Li ion batteries have been developed.

However, the secondary batteries need charging operation after the consumption of power. Accordingly, charging equipments and relatively long charging time are necessary, which brings about many problems against demands on a long term continuous drive of the portable electronic appliances. In order to meet the demands for increase amount of information to be processed and high speed processing, small sized power generators (i.e. micro-power generators) with higher output and higher energy density as well as a longer continuous operation time have been desired.

As a power source that meets the above demands, fuel cells may be a typical example. Fuel cells can directly convert chemical energy of fuel into electric energy by an electro-chemical manner. Thus, they do not need a conventional power driven generator such as an internal combustion engine; they have a high possibility as a small sized power generation device. Further, since the fuel cells can work continuously simply by exchanging fuel or supplying fuel to them, it is not necessary to stop temporarily the appliances at the time of charging them, which often needs in case of conventional secondary batteries.

Fuel cells that use liquid fuel such as methanol, ethanol, propanol, dimethylether, ethylene glycol, etc. have an increase expectation as a small sized, long term operation power source for small appliances. Patent publication 1 discloses proposal of controlling a supply amount of liquid fuel in accordance with change of a load current on time lapse.

Patent publication 1; Japanese patent laid-open 2003-22830

### BRIEF DESCRIPTION OF THE DRAWINGS

FIG. 1 is a diagram of a fuel cell power source system according to the present invention.

FIG. 2 is a perspective view of a liquid fuel recovery—supply apparatus for recovering used liquid fuel and supplying fresh liquid fuel.

FIG. 3 is a perspective view of a notebook type personal computer according to the present invention.

FIG. 4 is a perspective view of a notebook type personal computer of another embodiment of the present invention.

FIG. 5 is a perspective view of a notebook type personal computer of a further embodiment of the present invention.

FIG. 6 is a perspective view of a still another embodiment of the present invention.

FIG. 7 is a perspective view of a still another embodiment of the present invention.

FIG. 8 is a perspective view of a cartridge according to the present invention.

FIG. 9 is a perspective view of a cartridge of another embodiment of the present invention.

FIG. 10 is a perspective view of a notebook type personal computer installed with a fuel cell of another embodiment of the present invention.

FIG. 11 is a perspective view of a notebook type personal computer installed with a fuel cell of still another embodiment.

### DETAILED DESCRIPTION OF THE INVENTION

The personal computer using fuel cell using liquid fuel as disclosed in patent publication No.1 may guarantee a predetermined output as long as it uses liquid fuel having a predetermined fuel concentration. However, after the fuel cell is operated for a long period of time, ionic impurities accumulate in the liquid fuel, which leads to an increase in electrical conductivity of the liquid fuel. This phenomenon brings about short-circuit current to lower the output; the cell does not perform its function as a fuel cell by breakdown of insulation. Furthermore, the ionic impurities in the liquid fuel make ionic bonds with an electrolyte membrane thereby to lower proton conductivity of the membrane, or to poison the catalyst in the electrode.

In order to remove the problem, a filter or ion exchange resin is disposed in a circulation passage for the liquid fuel solution to remove impurities in the solution, but it is difficult to remove the impurities for a long time.

It is an object to provide a fuel cell that can control the concentration of ionic impurity in the liquid fuel to a low level and is capable of operating for a long time, and also provides an electronic appliance using the same and a business method.

In order to control the concentration of the ionic impurities in the liquid fuel in a circulation passage, the liquid fuel is withdrawn from the fuel cell, when an output of the fuel cell is dropped or at the time of fuel charging, a new liquid fuel is supplied to the fuel cell.

The means for withdrawing the liquid fuel, which has been deteriorated and supplying the new liquid fuel brings about recovering of electric generation performance within a short time after the fuel charging.

### PREFERRED EMBODIMENTS OF THE INVENTION

In the following, preferred embodiments for practicing the present invention are explained; however, the present invention is not limited to them.

In one embodiment of the present invention, the fuel cell system comprises a circulating container for supplying liquid fuel having a predetermined concentration to a fuel cell and for recovering liquid fuel discharged from the fuel cell and storing it, and a fuel container for accommodating the liquid fuel, wherein at least one of the circulating container and the fuel container is detachable from the fuel cell.

The fuel cells of which performance is deteriorated are recovered by replacing the circulating container and the fuel container with new ones. Further, there is provided a fuel cell system, which comprises a circulating container for supplying liquid fuel to the fuel cell and recovering the liquid fuel discharged from the fuel cell and storing it. When an ionic impurity concentration of the liquid fuel exceeds a predetermined value, or when an generation output of the fuel cell does not meet a predetermined output vale, the liquid fuel in the fuel cell is withdrawn and new liquid fuel is supplied to the fuel cell.

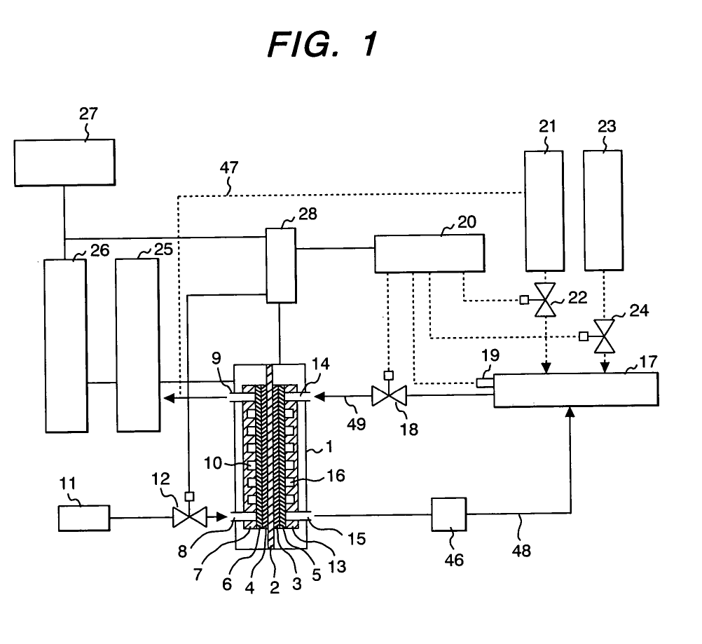

The fuel cell system comprises at least a fuel cell, a circulating container and a fuel container, and the system may have a fuel concentration control device, a product water container and a concentration sensor as shown in FIG. 1. The fuel cell comprises an anode, electrolyte membrane, a cathode and gas dispersion layers, wherein the fuel is oxidized at the anode and the oxygen is reduced at the cathode to generate electric power.

The fuel cell in one embodiment is a DMFC (Direct Methanol Fuel Cell), which uses methanol; the liquid fuel may be methanol, dimethylether, ethylene glycol, etc. The concentration of the supplied liquid fuel is not particularly limited. However, the energy density increases as the concentration of the fuel reaches 100%, and if the volume of the liquid fuel with a higher concentration is the same, the operating time of the fuel cell becomes longer.

Suppose that the electric output of the fuel cell is 80% of the rated output (a predetermined output at a predetermined concentration of fuel). Analysis of the ionic substances of the methanol aqueous solution under the above output condition have revealed that Cr ions were 0.05 to 0.1%, Fe ions 0.02 to 0.06%, Ni ions 0.0003 to 0.002%, and other ions such as Na, Ca. It has been found that when an amount of the total ionic substances exceeds 0.1%, the output of the fuel cell becomes 80% or less of the rated output. Accordingly, when the concentration of the ionic substances becomes 0.1% or more, preferably 0.05% or more, more preferably 0.01% or more, the liquid fuel is withdrawn and new liquid fuel is supplied.

The method of fuel cell employs a refreshing process for withdrawing the used and deteriorated fuel containing ionic substances. The refreshing process should be carried out when the output of the fuel cell lowers, or at the time of fuel charging. Particularly, it is preferable to carry out the refreshing by charging new fuel, while withdrawing the used fuel. Methods of judging the output decrease of the fuel cell are not limited; it is preferable to judge the timing of output reduction when the output voltage decreases to 80% or less of the rated voltage. An amount of the liquid fuel to be refreshed in the circulating container is sufficient. If the circulating container is exchangeable, the refreshing process is simply carried out by exchanging the circulating container.

As another example for refreshing, there is a fuel cartridge, wherein the inside of a fuel charger for charging fuel is divided by a fuel impermeable flexible membrane, whereby supply of fuel and recovery of used fuel are carried out at home or outside home.

A business method is conceivable using the fuel recovering and supply system; liquid fuel recovery and supply apparatuses of the present invention may be equipped at shops such as convenience stores, station kiosks, hotels, coffee shops, supermarkets, post offices, banks, gas stations, etc.; upon requests of fuel cell users, the used fuel is withdrawn from the fuel cells and new fuel is supplied to the fuel cells. The liquid fuel supply apparatus for the fuel cell reads out information on tags attached to the fuel cells of notebook type personal computers, PDAs', portable telephones, etc., thereby to prepare liquid fuel of a desired concentration in accordance with the information. When the fuel cells are placed on cradles of the liquid fuel recovery-supply apparatus, connection between the fuel recovery and supply apparatus and the fuel cell starts automatically. Upon detection of the completion of connection between the apparatus and the fuel cell, the recovery and supply process starts. The recovery and supply are automatically finished. The fuel supply unit and the recovery unit may be disposed in separate containers or in a single container. The fuel supply unit may store liquid fuel of a predetermined concentration in advance.

The filter for removing ions or ionic impurities in the circulating container may be replaced with a new one at the time of refreshing process. The ionic impurities are generated by dissolving pipings, catalysts, etc., which are mainly metal ions.

Although the liquid fuel supplied to the circulating container or the fuel container may have a concentration to be supplied to the fuel cell from the beginning, such a high concentration liquid fuel as 95% or more is charged in the fuel cell and is mixed with water to prepare a fuel solution of a desired concentration. This process is preferable because an integral value of output/time per unit volume is high.

As a polymer electrolyte membrane used for he fuel cell, any electrolyte membranes, which has ionic conductivity can be used. Materials for the membranes are fluorine series electrolyte polymers, partially fluorine series polymers, hydrocarbon series electrolyte polymers, etc. Fluorine series polymer electrolytes used in this embodiment are polymers. Examples are: copolymers of fluoro-vinyl compounds represented by a general formula CF₂═CF—(OCF₂CFX)ₘ—O_{q}—(CF₂)ₙ-A (m=0−3, n=0−12, q=0 or 1, X═F or CF₃, A=a functional group of sulfonic acid type) and perfluoroolefin such as tetrafluoroethylene, hexafluoroethylene, chlorotrifuluoroethylene, perfluoroalkoxyvinyl ether, etc. Preferable fluoro-vinyl compounds are exemplified as:
CF₂═CFO(CF₂)₁₋₈SO₂F
CF₂═CFOCF₂CF (CF₃) (CF₂)₁₋₈SO₂F
CF₂═CF(CF₂)₀₋₈SO₂F
CF₂═CF(OCF₂CF(CF₃))₁₋₅O(CF₂)SO₂F

Materials for hydrocarbon electrolyte membranes are: membranes made of sulfonated engineering plastics such as sulfonated polyetherether ketone, sulfonated polyether sulfone, sulfonated polyether sulfone, sulfonated polyetherethersulfone, sulfonated polysulfide, sulfonated polyphenylene, etc.; membranes made of sulfo-alkyalted engineering plastics such as sulfo-alkylated polyetherether ketone, sulfo-alkyalted polyether sulfone, sulfo-alkyalted polyetherether sulfone, sulfo-alkyalted polysulfone, sulfo-alkylated polysulfide, sulfo-alkylated polyphenylene, etc. Among them, preferable materials are sulfo-alkyalted engineering plastics such as sulfo-alkylated polyetherether ketone, sulfo-alkyalted polyether sulfone, sulfo-alkyalted polyetherether sulfone, sulfo-alkyalted polysulfone, sulfo-alkylated polysulfide, sulfo-alkylated polyphenylene, from the view points of fuel permeability and ionic conductivity.

By using composite membranes wherein inorganic oxides of hydrogen ion conductivity such as tungsten oxide hydroxide, zirconium oxide hydroxide, tin oxide hydroxide, silico-tungstate, silico-molybdate, tungstophosphate, molybdophosphate, etc. are micro-dispersed in a thermoplastic polymer, fuel cells with higher operating temperature are obtained.

The above-mentioned hydroxide type acidic electrolyte membranes may bring about deformation due to swelling in wetted condition, so that their mechanical strength may be insufficient in case where the membranes have high ionic conductivity. In such case, reinforcing core materials of fibers with high mechanical strength, endurance and heat resistance are used as non-woven or woven state. The fibers are added as reinforcing fillers to the electrolyte material, thereby to increase reliability of the fuel cell performance.

In order to reduce fuel permeability of the electrolyte membranes, membranes of polybenzoimidazoles doped with sulfuric acid, phosphoric acid, sulfonic acids, phosphonic acids may be used. A sulfonate equivalent of the polymer electrolyte is preferably 0.5 to 2.0 mEq/g dry resin, more preferably 0.7 to 1.6 mEq/g dry resin. If the sulfonate equivalent is less than that, the ionic conductive resistance will be larger, and if the equivalent is smaller than that, the membranes will be dissolved in water, which is not proper for fuel cells.

Gas diffusion electrodes used in electrolyte/electrode bonded members for fuel cells are constituted by conductive materials supporting fine particles of a catalyst. If desired, a water repellent material or adhesives may be contained. A layer comprising conductive materials not supporting catalysts and water repellent material or adhesives can be formed on the surface of the gas diffusion electrode bonded members.

As catalyst materials for the gas diffusion electrode, any catalysts that accelerate reduction reaction of hydrogen and oxidation reaction of fuel are used. For example, there are platinum, gold, silver, palladium, iridium, rhodium, ruthenium, iron, cobalt, nickel, chromium, tungsten, manganese, vanadium, or their alloys. Among the catalysts, platinum is particularly useful. A particle size of the catalyst is normally 10 to 300 angstroms. The catalysts are supported on carriers such as carbon so as to save an amount of the catalyst. A supporting amount of the catalyst is within a range of 0.01 to 10 mg/cm².

As conductive materials that have electron conductivity, various metal materials or carbon materials are used. Carbon materials are furnace black, channel black, acetylene black, activated carbon, graphite, etc. They are used singly or in combination.

As water repellent agents, fluorinated carbon, etc. are used. As a binder, the binder used in the embodiments is preferably used from the vie point of adhesiveness, but other binder resins can be used. Other water repellent resins such as polytetrafluoroethylene, tetrafluoroethylene-perfluoroalkyl vinylether copolymer, tetrafuluoroethylene-hexafluoroethylene copolymer, etc. may be added to the binder.

Bonding method of preparing the composite electrolyte membrane and electrodes are not limited. For example, platinum catalyst powder supported on carbon is mixed with a polytetrafluoroethylene suspension solution, the mixture is coated on paper, and heated to form a catalyst layer. Then, The same solution as the electrolyte composite membrane is coated on the catalyst layer, followed by hot-pressing to unite the membrane and the electrode. There are: a method of coating the same electrolyte solution as that of electrolyte membrane on the catalyst power; a method of coating a catalyst paste on the electrolyte composite membrane; a method of electroless plating electrode metal on the composite electrolyte membrane; and a method of effecting adsorption of chelate ions of platinum group element on the composite electrolyte membrane, followed by causing reduction of the ions.

The circulating container should be any materials as long as they are thin and sufficient strength materials, which should be electro-chemically inactive, and should be of durability and corrosion resistance under the operating atmosphere. There are, for example, polyethylene, polypropylene, polyethylene terephthalate, polyvinyl chloride, polyacrylate resins, and other engineering plastics, reinforced resins with fillers. Materials that are of corrosion resistance under the atmosphere on the fuel cell operation such as carbon materials, stainless steel, or surface treated metals of iron, nickel, copper, aluminum, etc. and their alloys with a corrosion resistive and electro-insulative coating can be used. The materials for he circulating container is not limited as long as it is inactive and corrosion resistive and has a sufficient strength.

In another embodiment, the present invention provides a fuel recover—supply apparatus for a fuel cell, which comprises a fuel container for storing liquid fuel, a water storing container for storing water (pure water at the time of production) produced at a cathode of the fuel cell, a circulating container for storing an aqueous fuel solution of a predetermined concentration, a fuel concentration control device for controlling the concentration of the aqueous fuel solution, a liquid transport pump for supplying the liquid fuel to the liquid fuel and the produced water to the circulating container in response to the control device, a pipe line for supplying the aqueous fuel solution in the circulating container to a fuel cell, a fuel recovery pipe line for recovering the liquid fuel in the fuel container in response to the control device, and a recovered fuel container. If the fuel supply and recover apparatus is installed at shops such as convenience stores, station kiosks, hotels, coffee shops, etc., the aqueous fuel solution can be recovered from and supplied to the fuel container of the fuel cells.

In the following, the preferred embodiments of the present invention will be explained in detail.

(Embodiment 1)

FIG. 1 shows a diagrammatic view of a fuel cell system which employs a methanol fuel cell (DMFC) for a personal computer. The fuel cell of this embodiment comprises an electrolyte/electrode assembly (MEA), which is constituted by an anode catalyst layer 3 and a cathode catalyst layer 4 and a polymer electrolyte membrane 2 sandwiched by the catalyst layers, an anode collector 5 at the anode side, a cathode collector 6 at the cathode side, each being closely contacted. An air flow plate 7 is disposed at the cathode collector 6 side, the air flow plate 7 being provided with an air flow passage having an air supply port 8 and an air discharging port 9.

The air flow passage 10 is connected to an oxidant supply means including a blower or a fan for supplying air 11 containing oxygen. At the same time, water produced by reduction reaction of oxygen at the cathode is discharged from the air discharging port 9. The recovered water is stored in the produced water storing container 21 by means of the water recovering pipe line 47. The fuel flow plate 13 is disposed at the anode side. The fuel flow plate 13 is provided with fuel flow passage 16 having a fuel supply port 14 and a fuel discharging port 15.

Discharged fuel is recovered through a fuel recovering pipe line 48 to which an ion exchange resin and a filter 46 are connected to an aqueous fuel solution container 17. The ion exchange resin removes metal ions in the fuel solution and the filter removes impurity particles in the solution.

The aqueous fuel solution container 17 is connected through the fuel supply pipe line 49 and the liquid supply pump 18 to the fuel supply port 14, thereby to circulate the methanol liquid. The aqueous methanol solution flows in the grooves (fuel passage 16) of the fuel flow plate 13 through the fuel supply port 14 of the fuel flow plate 13. The projected portions of the fuel flow plate 13 make contact with an anode collector made of carbon paper, for example; the aqueous methanol solution flowing the fuel flow passage 16 is soaked into the anode collector 5 so that the aqueous methanol solution is supplied to the anode catalyst layer 3.

The aqueous methanol solution supplied to the anode catalyst layer 3 reacts in accordance with the equation (1) to be dissociated to carbon dioxide, protons and electrons.
CH₃OH+H₂O→CO₂+6H⁺+6e⁻ (1)

Produced protons move through the polymer electrolyte membrane 2 from the anode to the cathode. The protons react with oxygen gas and electrons on the cathode catalyst 4 to produce water in accordance with the following equation (2).
6H⁺+3/2O₂+6e⁻→H₂O (2)

Accordingly, the whole chemical reactions are expressed by equation (3); methanol is oxidized by oxygen to produce carbon dioxide and water as shown in equation (3). That is, the reaction is equivalent to flame combustion of methanol.
CH₃OH+3/2O₂→CO₂+3H₂O (3)

In the fuel cell using the aqueous methanol solution, electric power generation takes place in the form that the chemical energy of methanol is converted into electric energy. However, there is a rare case where all aqueous methanol solution flowing in the fuel flow plate 13 permeates in the anode collector 5, but part of the solution is discharged from the fuel discharge port 15 of the fuel flow plate 13. Therefore, the utilization efficiency of the methanol solution is generally low. In order to increase the efficiency, attempts for improving the shape of the flow plate have been made, but the remarkable improvement of efficiency is not attained so far. It may be possible to employ a system for returning the methanol solution discharged from the fuel discharge port 15 of the fuel flow plate 13 to the fuel solution container 17. However, since the water and methanol are consumed at the anode catalyst layer 3 at a ratio of 1:1, a circulating passage for returning methanol solution to the fuel solution storing container 17 is formed, which leads to slow dilution of the methanol solution. Thus, shortage of methanol in the fuel cell takes place to drastically decrease output of the fuel cell.

The concentration of the methanol solution is detected by a methanol concentration sensor 19, and the information is sent to the methanol concentration control device 20. The control device 20 controls the liquid supply pump 24 connected to the product water container 21 and the liquid supply pump 24 connected to the liquid fuel container 23 so as to maintain the concentration of methanol in the solution. Part of the product water discharged from the air discharging port 9 together with air is returned to the product water container 21. A high concentration methanol in the fuel container 21 is supplied to the fuel solution container 17 by means of a fuel cartridge.

Electrons generated as shown in equation (1) flow through the collector to generate a voltage, which is elevated by the DC/DC converter 25. The terminal is connected to an outer circuit 27 through a lithium ion secondary battery or a super capacitor 26. The lithium ion secondary battery or super capacitor 26 drives a power source 28 for a control device 20, a liquid supply pump 22, 24, a blower 12, etc. Part of the generated electric power flows through the anode collector and a cathode collector to drive the electric power source 28 for the fuel concentration control device 20, a liquid supply pump 22, 24, etc.

The anode catalyst layer 3 was prepared in such a manner that fine powder of alloy of platinum and ruthenium (1:1) was dispersed on carbon supporter at 50% by weight and as a binder resin a solution of 30% perfluorocarbon sulfonate polymer trade name Nafion 117, manufactured by DuPont) were mixed to make a slurry. The polymer was dispersed in a mixed solvent consisting of water: isopropanol: normal propanol at 20:40:40. The slurry was printed by a screen printing method on polyimide film at a thickness of about 20 μm to make a porous film. The catalyst layer 4 was prepared in such a manner that catalyst power of platinum fine particles supported on carbon at 30% by weight and as the binder resin the electrolyte resin slurry dispersed in a mixed solvent consisting of water/alcohol were mixed to make a slurry.

The slurry was coated on polyimide film by a screen printing method to produce a porous film of a thickness of about 25 μm. The anode porous layer and the porous cathode layer were cut into 10 mm width×20 mm length to prepare the anode catalyst layer 3 and the cathode catalyst layer 4.

0.5 mL of a 5 weight % aqueous solution of Nafion 117 in a mixed solvent consisting of water; isopropanol: normal popanol=20:40:40, manufactured by Fluka Chemicals was caused to permeate the anode catalyst layer. Then, the anode catalyst layer was dried on the above mentioned electrolyte membrane (Nafion 117 of a thickness 50 μm) under a load of about 1 kg at 80° C. for 3 hours.

Thereafter, 0.5 mL of a 5 weight % aqueous solution of Nafion 117 in a mixed solvent consisting of water; isopropanol: normal popanol=20:40:40, manufactured by Fluka Chemicals was caused to permeate the cathode catalyst layer. Then, the anode catalyst layer was bonded to the above mentioned electrolyte membrane 2, followed by drying under a load of about 1 kg at 80° C. for 3 hours to prepare the membrane/electrode assembly (MEA).

Next, an aqueous dispersion of polytetrafluoroethylene fine particles (Dispersion D-1, manufactured by Daikin Corp.) was added to carbon powder at such an amount that a weight after sintering is 40% by weight, and the materials were mixed to make a paste like composition.

The composition was coated on one face of woven carbon fiber cloth of a thickness of about 350 μm and a porosity of 87% at a thickness of about 20 μm. Then, the coating was dried at room temperature, followed by sintering at 270° C. for 3 hours to prepare carbon sheet. The resulting sheet was cut into the same size as that of the electrode of MEA to prepare diffusion layers. Using these parts, a fuel cell system shown in FIG. 1 was assembled.

The concentration of the aqueous solution in the fuel aqueous solution container, which is also used as the circulating container, was monitored by a methanol concentration sensor 19. If the concentration decreases or the amount of methanol is short, recovered product water in the product water container 21 and methanol of high concentration stored in the fuel container 23 were supplied by the liquid supply pump 22, 24 in response to the methanol concentration control device 20 to control the concentration methanol to be supplied to the fuel cell to a predetermined concentration such as 10 to 30%. Regardless of the control, the fuel cell lowers its output after about 50 hours and it turns incapable to operate. Even when fresh methanol in the fuel container 23 was supplied, the output did not reach the predetermined value.

Thus, in the fuel cell system 1 shown in FIG. 1, the concentration of methanol in the aqueous fuel solution container 17 was detected by the concentration sensor 19 to control the concentration to the predetermined value. When the output decreased to 80% of the predetermined value, the aqueous methanol solution in the fuel cell was replaced with a fresh methanol solution by supplying water in the product water container 21 and high concentration methanol in the fuel container by means of the liquid supply pumps 22, 24, while the aqueous methanol solution was withdrawn. As a result, the output of the fuel cell was recovered. Repeating this process made it possible to operate the fuel cell for at least 1000 hours. According to this embodiment, the service life of the fuel cell will be remarkably extended, when fresh liquid fuel is supplied at the time when the output reduction is detected or at the time of fuel charging.

(Embodiment 2)

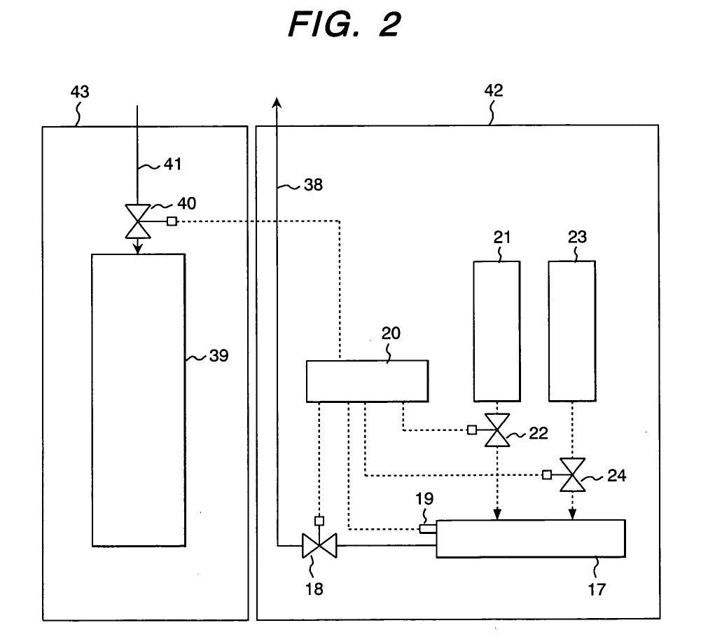

FIG. 2 shows a diagram of a fuel recovery—supply apparatus, which carries out fuel recovery and fuel supply, simultaneously. The fuel recovery—supply apparatuses are installed at convenience stores, railway kiosks, hotels, coffee shops, etc. for recovering used fuel that contains ionic impurities, etc. and supplying fresh liquid fuel upon requests of users of personal computers, PDAs', portable telephones, etc. that are equipped with fuel cells. As explained in the embodiment shown in FIG. 1, liquid fuel solution in the fuel solution container 17 accumulates ionic impurities as the operation time lapse to thereby lower the output, resulting in its short life span, since the liquid fuel circulates through the container 17 and the fuel cell.

The concentration of the ionic impurities in the used liquid fuel in the liquid fuel solution container 17 is detected. When the concentration exceeds the predetermined value, the liquid fuel is recovered and replaced by the apparatus shown in FIG. 2.

Detected ionic impurities in the liquid solution of which output remarkably lowers are mainly metal ions such as Cr ions in the range of 0.05 to 0.1%, iron ions 0.02 to 0.06%, Ni ions 0.0003 to 0.002%, and other ions including sodium, calcium, etc. When the concentration of the sum of metal ions exceeds 0.1%, the output decreased. Accordingly, in this embodiment, the liquid fuel was discharged and replaced with fresh fuel when the concentration reaches 0.01%.

A method of supplying fresh liquid fuel is as follows. At first, used liquid fuel in the fuel cell is communicated with the fuel discharge port 15 of the fuel pipe line 41 at the fuel recovery section 43. Upon the signal of connection, the fuel supply pump 40 is driven in response to the methanol concentration control apparatus 20, thereby to suck the old fuel into the fuel recovery container 39.

Then, information on kinds of fuel and concentration of the users' fuel cells are input in the fuel supply section 42 in advance, and the information is sent to the methanol concentration control apparatus 20, which adjusts the concentration of the liquid fuel solution by controlling the liquid supply pump 22 connected to the water storage container 21 and the liquid supply pump 24 connected to the methanol solution container 23. After the liquid fuel supply port 14 is connected to the liquid fuel supply pipe line 38, the liquid supply pump 18 is driven to supply fuel to the fuel cell.

When notebook type personal computers, portable telephones, PDAs, etc. are placed on the cradle of the fuel recovery—supply apparatus, a needle is inserted to recover used liquid fuel from the fuel cells and supplying fresh liquid fuel to the fuel cells are started. In other words, the fuel recovery—supply apparatus is automatically connected to the methanol aqueous solution tank 17 to start withdrawal of fuel and start the supply of new methanol fuel. Upon the completion of the recovery and supply of the liquid fuel, the needle is withdrawn. As a result, the used fuel is replaced with fresh liquid fuel having a predetermined concentration and being free from metal ion impurities, whereby the output of the fuel cell is recovered. By repeating the above operation, the service life of the fuel cell will last long as 1000 hours or more.

In case the output of the fuel cell becomes lower than a rated output, the same counter-measure will be applied.

(Embodiment 3)

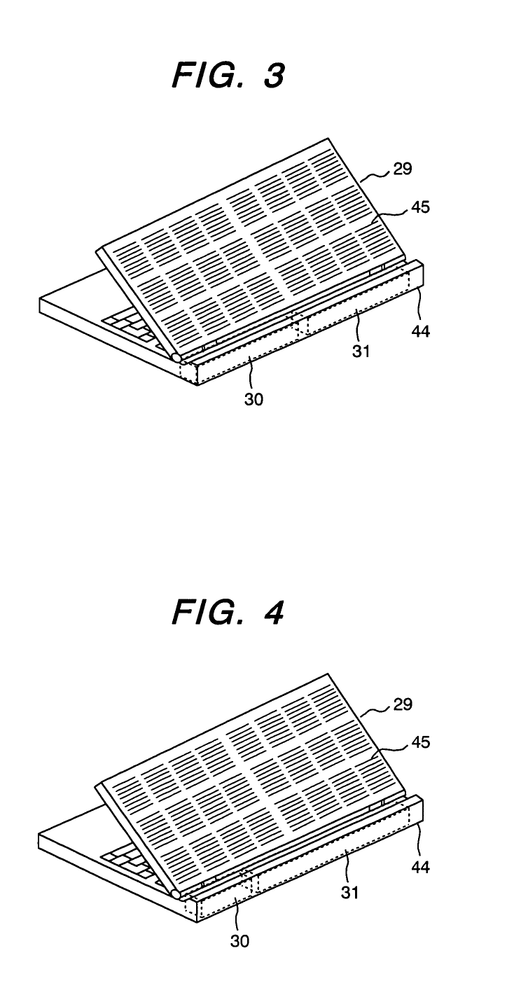

FIG. 3 shows a perspective view of a personal computer that employed the fuel cell system according to the present invention. This embodiment is concerned with a personal computer wherein a panel type fuel cell power source section 29 is accommodated in a liquid display. Slits in the surface of the power source shown in FIG. 3 are air intake ports 45. As shown by dotted lines at hinges, the fuel circulating tank 30 for methanol solution of a predetermined concentration and methanol fuel tank 31 are held on the holder means 44.

Methanol fuel is supplied to the liquid fuel solution circulating tank 30 from the methanol fuel tank 31 successively. If the output of the fuel cell gets down to less than 80% of the rated output at the time that fuel is supplied to the liquid fuel tank 31 from the fuel charger, the fuel circulating tank 30 that has been used is replaced with a new one. If the replacement is repeated, the service life of the fuel cell will be extended to 1000 hours or longer. The fuel tank 31 is also replaceable with another one.

If the fuel circulating tank 30 that has been used is not replaced with another one containing the predetermined fuel solution when fuel is supplied to the fuel tank 31 by the fuel charger, the fuel cell drops the output within about 50 hours, which leads to malfunction of the fuel cell. According to this embodiment, upon indication of drop of the output, used fuel is withdrawn from the fuel cell and fresh fuel is supplied. As a result, the service life of the fuel cell is extended.

If desired, the methanol tank 31 can be omitted, and the supporting member 44 can be made an fuel aqueous solution circulating tank 30 as a whole.

(Embodiment 4)

FIG. 4 shows a perspective view of a notebook type personal computer installed with a fuel cell. This embodiment employs a power source 29 of the panel type fuel cell disposed in the liquid crystal display.

In this embodiment, the volume of the methanol aqueous solution fuel circulating tank 30 is considerably smaller than that of the methanol tank 31 in embodiment 3. Not only the methanol aqueous solution circulating tank 30 but also the fuel tank 31 is replaceable. As shown by dotted lines at the hinges, the methanol aqueous solution circulating tank 30 for the methanol solution of the predetermined concentration and the methanol fuel tank are held by the holding means 44.

If the output of the fuel cell is 80% or less of the rated output at the time the fuel is supplied to the methanol fuel tank 31 by charging with the fuel charger, the methanol aqueous solution circulating tank 30 containing fuel that has been used is replaced with a new one containing methanol solution of the predetermined concentration. By repeating the replacement of the methanol aqueous solution circulating tank 30, the service life of the fuel cell could be prolonged.

In case where the methanol aqueous solution circulating tank 30 that contains fuel having been used is not replaced at the time of charging fuel with the fuel charger, the fuel cell dropped its output within about 50 hours, and became malfunction.

Since the volume of the methanol fuel tank 31 is about 4 times that of the methanol aqueous solution circulating tank 30, one charge makes about 4 times longer service life of the fuel cell than does the fuel cell in embodiment 3. From this fact, it is evident that the withdrawal of used fuel from the fuel cell and charge of new fresh fuel to the fuel cell remarkably prolong the service life of the fuel cell.

(Embodiment 5)

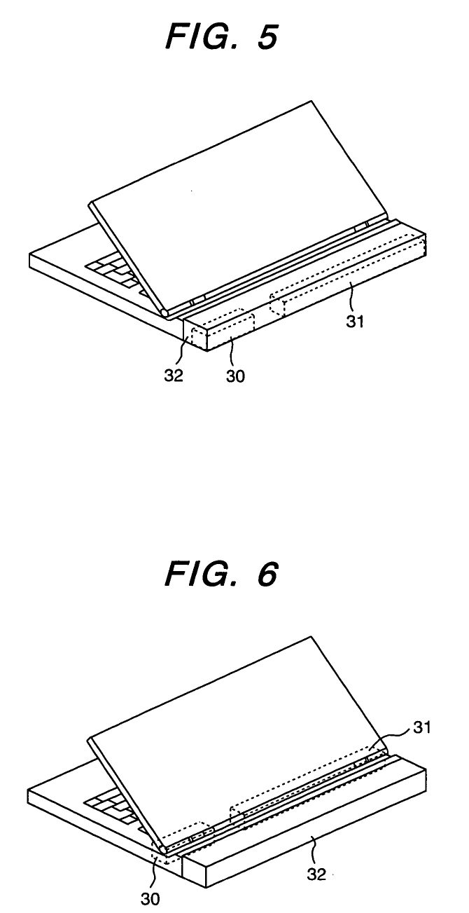

FIG. 5 shows a perspective view of a notebook type personal computer installed with a fuel cell system according to the present invention. In this embodiment, the fuel cell power source 32 is disposed at the hinges of the personal computer. The fuel cell is designed as being exchangeable with a Li battery. The methanol aqueous solution fuel circulating tank 30 and the methanol fuel tank 31 are replaceable. The fuel cell power source 32 is equipped with auxiliary machinery and control devices such as a methanol aqueous solution circulating tank 30, a methanol fuel tank 31, a stacked power generation section, a liquid supply pump, a blower, etc. A DC/DC converter, lithium secondary battery and a super-capacitor may be disposed to the fuel cell power source 32 or to the notebook type personal computer. If the output of the fuel cell is 80% or less of the rated output at the time the fuel is supplied to the methanol fuel tank 31 by charging with the fuel charger, the methanol aqueous solution circulating tank 30 containing fuel that has been used is replaced with a new one containing methanol solution of the predetermined concentration. By repeating the replacement of the methanol aqueous solution circulating tank 30, the service life of the fuel cell could be prolonged.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

(Embodiment 6)

FIG. 6 shows a perspective view of a notebook type personal computer installed with a fuel cell system according to the present invention. In this embodiment, the fuel cell is disposed at the hinge. The fuel cell is exchangeable with a Li battery. The methanol aqueous solution fuel circulating tank 30 and the methanol fuel tank 31 are replaceable. The fuel cell power source 32 is equipped with auxiliary machinery and control devices such as a methanol aqueous solution circulating tank 30, a methanol fuel tank 31, a stacked power generation section, a liquid supply pump, a blower, etc. A DC/DC converter, a lithium secondary battery and a super-capacitor may be disposed to the fuel cell power source 32 or to the notebook type personal computer.

If the output of the fuel cell is 80% or less of the rated output at the time the fuel is supplied to the methanol fuel tank 31 by charging with the fuel charger, the methanol aqueous solution circulating tank 30 containing fuel that has been used is replaced with a new one containing methanol solution of the predetermined concentration. By repeating the replacement of the methanol aqueous solution circulating tank 30, the service life of the fuel cell could be prolonged.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

(Embodiment 7)

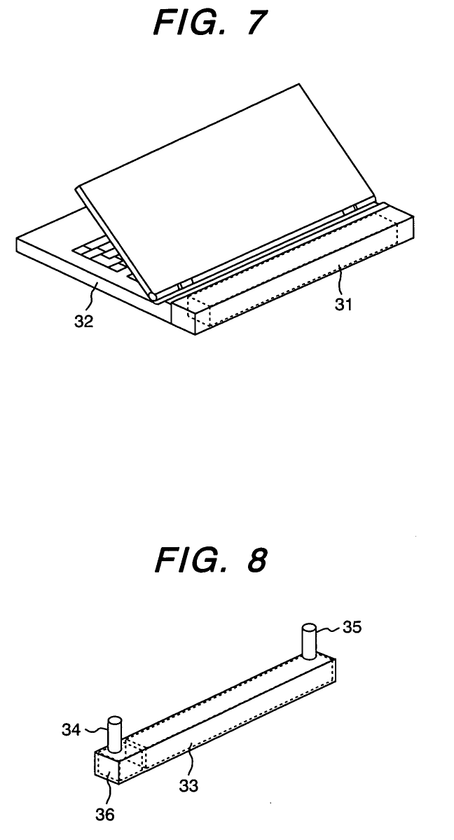

FIG. 7 shows a perspective view of a notebook type personal computer equipped with a fuel cell system according to the present invention. In this embodiment, the fuel cell is disposed at the hinge. The fuel cell is replaceable with a Li battery. The methanol aqueous solution fuel circulating tank 30 and the methanol fuel tank 31 are exchangeable. The fuel cell power source 32 is equipped with auxiliary machinery and control devices such as a methanol aqueous solution circulating tank 30, a methanol fuel tank 31, a stacked power generation section, a liquid supply pump, a blower, etc. A DC/DC converter, a lithium secondary battery and a super-capacitor may be disposed to the fuel cell power source 32 or to the notebook type personal computer.

If the output of the fuel cell is 80% or less of the rated output at the time the fuel is supplied to the methanol fuel tank 31 by charging with the fuel charger, the methanol aqueous solution circulating tank 30 containing fuel that has been used is replaced with a new one containing methanol solution of the predetermined concentration. By repeating the replacement of the methanol aqueous solution circulating tank 30, the service life of the fuel cell could be prolonged.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

(Embodiment 8)

FIG. 8 shows a perspective view of a fuel cartridge according to this embodiment. When the methanol aqueous solution fuel that has been used was withdrawn from the circulating tank 30 and fresh fuel with a predetermined concentration is supplied to the methanol tank 31 shown in embodiment 6, the cartridge shown in FIG. 8 was used. By this cartridge, the fuel recovery and fuel supply were carried out simultaneously. The inside of the fuel cartridge charger was divided by a flexible, methanol impermeable polymer membrane into two sections, one of which accommodates a fuel absorber 36, and the other of which stores fuel.

The methanol aqueous solution circulating tank 30 is connected to the fuel suck port where the fuel absorber is filled, the fuel in the methanol aqueous solution circulating tank 30 was transported to the fuel absorber 36 by capillary action, so that the fuel absorber swells. Using this swelling force, fuel was supplied through the fuel supply port to the fuel tank. The fuel cell could be used for more than 1000 hours.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

(Embodiment 9)

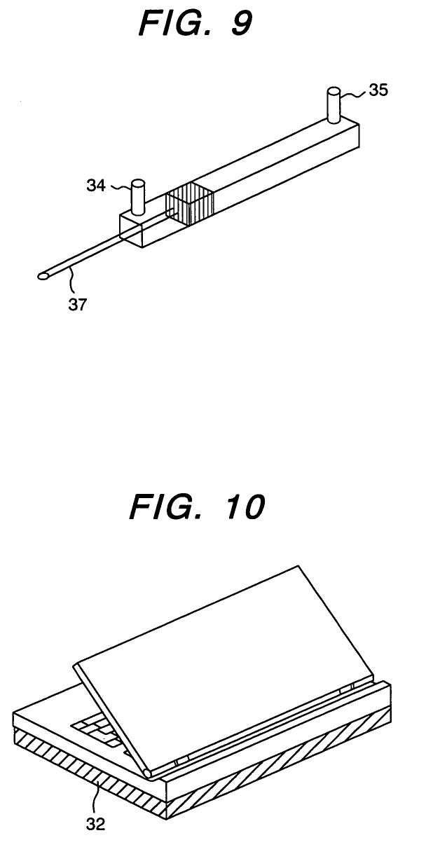

FIG. 9 shows a perspective view of a cartridge according to the present embodiment. When the methanol aqueous solution fuel that has been used was withdrawn from the circulating tank 30 and fresh fuel with a predetermined concentration is supplied to the methanol tank 31 shown in embodiment 6, the cartridge shown in FIG. 8 was used. By this cartridge, the fuel recovery and fuel supply were carried out simultaneously. The circulating tank shown in FIG. 6 was connected to the fuel suction port, and the fuel supply tank 31 was connected to the fuel supply port 35.

The fresh fuel was supplied to the fuel tank 31 by pressurizing the fuel with the piston 37, and the recovering side was made negative pressure to recover the used fuel. As a result, the fuel cell could be operated for 1000 hours or longer.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

(Embodiment 10)

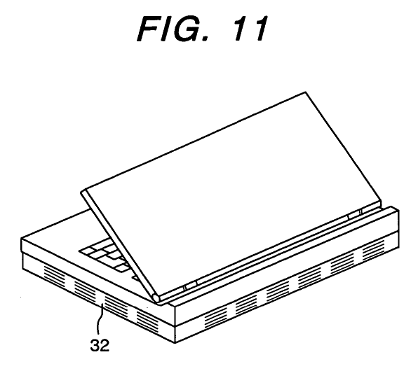

FIGS. 10 and 11 show perspective views of notebook type personal computers each being installed with a fuel cell according to the embodiments. The embodiment shown in FIGS. 10 and 11 are provided with the fuel cells beneath the notebook type personal computer body. If the output of the fuel cell is 80% or less of the rated output at the time the fuel is supplied to the methanol fuel tank 31 by charging with the fuel charger, the methanol aqueous solution circulating tank 30 containing fuel that has been used is replaced with a new one containing methanol solution of the predetermined concentration. By repeating the replacement of the methanol aqueous solution circulating tank 30, the service life of the fuel cell could be prolonged.

In case where the methanol aqueous solution circulating tank 30 that contains fuel having been used is not replaced at the time of charging fuel with the fuel charger, the fuel cell dropped its output within about 50 hours, and became malfunction. From this fact, it is evident that the withdrawal of used fuel from the fuel cell and charge of new fresh fuel to the fuel cell remarkably prolong the service life of the fuel cell.

Fuel cells that use liquid fuel have the problem that ionic impurities are accumulated in the fuel cells after a long operation time, and the output drop within a short time, which leads to malfunction of the fuel cell. According to the embodiments explained above, the problem was solved by:
(1) When the output of the fuel cell drops, or when fuel is charged, liquid fuel in the fuel cell is withdrawn and fresh fuel is supplied, and
(2) When the output of the fuel cell drops, or at the time of fuel charge, the filter or ion exchange resin disposed in the fuel circulating passage is exchanged with new one.

Further, the fuel cell systems according to the embodiments are used as a battery charger for secondary batteries installed in portable telephones, portable personal computers, portable audio devices, visual devices, and other portable information terminals. Without installing secondary batteries, the fuel cell are used as encased power source. As a result, the electronic appliances can work continuously for a long time by supplying fuel.

According to the present invention, the filter, ion-exchange resin, cartridge are replaceable to refresh the fuel. In the above embodiments, the circulating device may be omitted. In this case, the used fuel is discharged from the fuel cell at the time of fuel supply.

1. A fuel cell characterized by having a circulating container for supplying liquid fuel of a predetermined concentration to the fuel cell and for recovering and storing the liquid fuel discharged from the fuel cell, wherein the circulating container is replaceable.

2. A fuel cell characterized by having a circulating container for supplying liquid fuel of a predetermined concentration to the fuel cell and for recovering and storing the liquid fuel discharged from the fuel cell, and having a fuel container for supplying the liquid fuel to the circulating container, wherein at least one of the circulating container and the fuel container is replaceable.

3. The fuel cell according to claim 1, which further comprises a detector for detecting the concentration of the liquid fuel supplied to the fuel cell.

4. The fuel cell according to claim 1, which further comprises a controller for controlling the concentration of the liquid fuel to the predetermined concentration.

5. The fuel cell according to claim 1, which further comprises a filter for removing metal ions and/or impurities contained in the liquid fuel discharged from the fuel cell.

6. The fuel cell according to claim 1, which further comprises a fuel electrode, an oxidant electrode disposed to opposite to the fuel electrode, and an electrolyte membrane sandwiched by between the electrodes.

7. The fuel cell according to claim 6, wherein the liquid fuel is one of methanol, dimethylether, and ethylene glycol.

8. The fuel cell according to claim 2, which further comprises a detector for detecting the concentration of the liquid fuel supplied to the fuel cell.

9. The fuel cell according to claim 2, which further comprises a controller for controlling the concentration of the liquid fuel to the predetermined concentration.

10. The fuel cell according to claim 2, which further comprises a filter for removing metal ions and/or impurities contained in the liquid fuel discharged from the fuel cell.

11. The fuel cell according to claim 2, which further comprises a fuel electrode, an oxidant electrode disposed to opposite to the fuel electrode, and an electrolyte membrane sandwiched by between the electrodes.

12. The fuel cell according to claim 6, wherein the liquid fuel is one of methanol, dimethylether, and ethylene glycol.

13. An electronic appliance having a fuel cell installed therein, wherein the fuel cell is the fuel cell defined in claim 1.

14. An electronic appliance having a fuel cell installed therein, wherein the fuel cell is the fuel cell defined in claim 2.

15. The electronic appliance according to claim 14, which further comprises holders for holding cartridges of the circulating container and the fuel container.

16. The electronic appliance according to claim 14, which further comprises a fuel liquid impermeable polymeric membrane disposed between the circulating container and the fuel container.

17. The electronic appliance according to claim 14, wherein the circulating container has a piston which makes a reciprocating movement in the container to supply the liquid fuel to the fuel cell and to recover the liquid fuel used in the fuel cell as well.

18. A business method, which comprises installing liquid fuel recovering and supplying apparatuses for a fuel cell at one or more of shops, whereby the liquid fuel is recovered from fuel cells and new liquid fuel is supplied to fuel cells.
